(19) United States
(12) Patent Application Publication
(10) Pub. No.: US 2021/0197850 A1
(43) Pub. Date: Jul. 1, 2021

(54) UNMANNED VEHICLE TRAVELING METHOD AND APPARATUS

(71) Applicant: BAIDU ONLINE NETWORK TECHNOLOGY (BEIJING) CO., LTD., Beijing (CN)

(72) Inventors: Xiapeng PENG, Beijing (CN); Jiayong HUANG, Beijing (CN); Ruisuo WANG, Beijing (CN)

(21) Appl. No.: 16/769,990

(22) PCT Filed: Jun. 6, 2019
(86) PCT No.: PCT/CN2019/090271

§ 371 Date: Jun. 4, 2020

(30) Foreign Application Priority Data
Jul. 4, 2018 (CN) 201810724954.5

(51) Int. Cl. B60W 60/00; B60W 30/12; B60W 40/105

(52) U.S. Cl. CPC B60W 60/001; B60W 30/12; B60W 40/105; B60W 2554/80; B60W 2520/06; B60W 2520/14; B60W 2554/4041

(57) ABSTRACT

The present disclosure provides an unmanned vehicle traveling method and apparatus. The method includes: collecting a coordinate of a preceding vehicle according to a preset cycle; when detecting an initial coordinate of the preceding vehicle in a current cycle, determining a circular arc between the preceding vehicle and a present vehicle, wherein a central angle and a radius of the circular arc being determined according to the initial coordinate; performing calculation on the central angle, the radius of the circular arc and a predetermined number N of reference trajectory points according to a preset algorithm, and generating coordinates of N reference trajectory points of the present vehicle in a vehicle coordinate system in the current cycle; and generating a reference trajectory according to the coordinates of the N reference trajectory points, and controlling the present vehicle to travel according to the reference trajectory.

### CROSS-REFERENCE TO RELATED APPLICATIONS

This application is a US national phase application of International Application No. PCT/CN2019/090271, filed on Jun. 6, 2019, which is based on and claims priority to and benefits of Chinese Patent Application No. 201810724954.5, filed by BAIDU ONLINE NETWORK TECHNOLOGY (BEIJING) CO., LTD. on Jul. 4, 2018.

### FIELD

The present disclosure relates to the field of traffic safety technologies, and more particularly, to an unmanned vehicle traveling method and an apparatus.

### BACKGROUND

Integrating technologies such as automatic control, architecture, artificial intelligence, and visual computing, an unmanned vehicle, which is a product of the highly developed computer science, pattern recognition, and intelligent control technologies, and a significant indicator of a country's scientific research strength and industrial level, has broad application prospects in fields of national defense and national economy. Generally, in consideration of the safety of human life, unmanned vehicles have extremely high requirements on safety and reliability, and even require unmanned systems to be able to maintain safe traveling for a period of time in the event of sudden failures of certain conditions.

In the related art, an unmanned vehicle relies on a lane line captured by a camera to travel. However, obviously, when the camera fails or there is no lane line, such a method relying on the lane line detected by the camera may fail to be implemented or even brings danger. For example, during driving on a highway, when there are no lane lines on some road sections, or a lane line cannot be identified as the camera breaks down, given that there is no lane line for the unmanned vehicle's reference, the unmanned vehicle may be driven out of the lane even if changing the lane is not allowed, which is likely to cause a traffic accident.

### SUMMARY

Embodiments of the present disclosure provide an unmanned vehicle traveling method, including: collecting a coordinate of a preceding vehicle according to a preset cycle; in response to detecting an initial coordinate of the preceding vehicle in a current cycle, determining a circular arc between the preceding vehicle and a present vehicle, a central angle of the circular arc and a radius of the circular arc being determined according to the initial coordinate; performing calculation on the central angle, the radius of the circular arc and a predetermined number N of reference trajectory points according to a preset algorithm, and generating coordinates of N reference trajectory points of the present vehicle in a vehicle coordinate system in the current cycle; and generating a reference trajectory according to the coordinates of the N reference trajectory points of the present vehicle in the vehicle coordinate system in the current cycle, and controlling the present vehicle to travel according to the reference trajectory.

Embodiments of the present disclosure provide a computer device including a processor and a memory. The processor, by reading executable program codes stored in the memory, executes a program corresponding to the executable program codes to implement the unmanned vehicle traveling method as described in the above embodiments.

Embodiments the present disclosure provide a non-transitory computer-readable storage medium. When the computer program is executed by a processor, the unmanned vehicle traveling method as described in the above embodiments is implemented.

### BRIEF DESCRIPTION OF THE DRAWINGS

The above and/or additional aspects and advantages of the present disclosure will become apparent and more readily appreciated from the following descriptions made with reference to the accompanying drawings.

FIG. 1 is a flowchart of an unmanned vehicle traveling method according to an embodiment of the present disclosure.

FIG. 2 is a schematic diagram of a scene of determining a circular arc between a preceding vehicle and a present vehicle according to an embodiment of the present disclosure.

FIG. 3 is a schematic diagram of an application scenario of an unmanned vehicle traveling method according to an embodiment of the present disclosure.

FIG. 4 is a flowchart of an unmanned vehicle traveling method according to another embodiment of the present disclosure.

FIG. 5 is a flowchart of an unmanned vehicle traveling method according to yet another embodiment of the present disclosure.

FIG. 6 is a flowchart of an unmanned vehicle traveling method according to still yet another embodiment of the present disclosure.

FIG. 7 is a schematic structural diagram of an unmanned vehicle traveling apparatus according to an embodiment of the present disclosure.

FIG. 8 is a schematic structural diagram of an unmanned vehicle traveling apparatus according to another embodiment of the present disclosure.

### DETAILED DESCRIPTION

Embodiments of the present disclosure are described below in detail, examples of the embodiments are shown in accompanying drawings, and reference signs that are the same or similar from beginning to end represent the same or similar components or components that have the same or similar functions. The embodiments described below with reference to the accompanying drawings are exemplary, merely used to explain the present disclosure, and cannot be construed as a limit to the present disclosure.

According to the above analysis in the background, it is known that currently unmanned vehicles rely on lane lines detected by cameras. When a lane line cannot be detected due to reasons such as a failure of a camera or an absence of a lane line, an unmanned vehicle has a relatively severe potential safety hazard.

To solve the above technical problems, the present disclosure proposes an unmanned vehicle traveling method. In this method, position information of a preceding vehicle is fully utilized to plan a traveling trajectory of a present vehicle. Consequently, on the one hand, a restriction that unmanned driving relies on cameras is broken up, and on the other hand, planning the traveling trajectory of the present vehicle through a path that the preceding vehicle has already traveled ensures safety of traveling.

The following describes an unmanned vehicle traveling method and an unmanned vehicle traveling apparatus according to the embodiments of the present disclosure with reference to the accompanying drawings.

It should be noted that, although the unmanned vehicle traveling method according to the embodiments of the present disclosure is to ensure traveling safety in the event of a failure of a camera in a vehicle, etc., the unmanned vehicle traveling method provided by the embodiments of the present disclosure may also be adopted when the camera of the vehicle is not defective, and the use of the unmanned vehicle traveling method provided by the present disclosure may better ensure the traveling safety of the vehicle. That is, the method provided by the present disclosure and the traditional unmanned vehicle traveling method may be flexibly switched according to the needs of application scenarios.

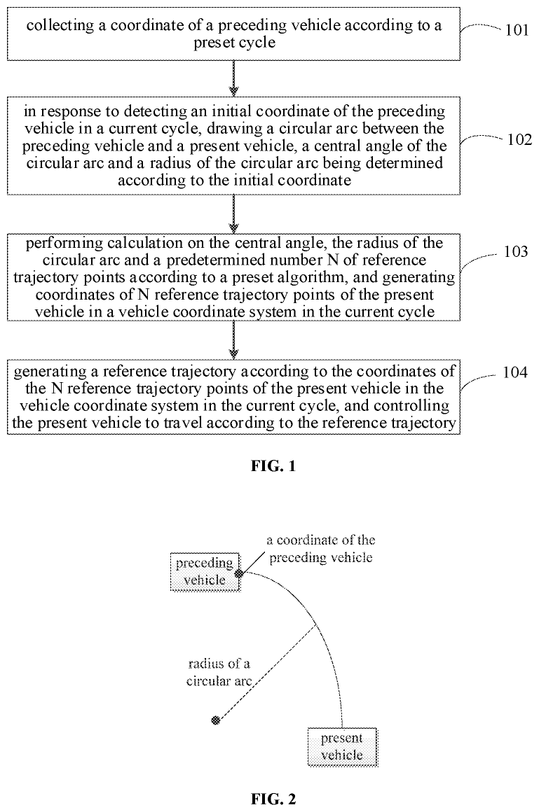

FIG. 1 is a flowchart of an unmanned vehicle traveling method according to an embodiment of the present disclosure. As illustrated in FIG. 1, the method includes the following.

At block 101, a coordinate of a preceding vehicle is collected according to a preset cycle.

The preset cycle is related to computing power of relevant processors, a natural motion frequency of a rigid body of the vehicle, a sampling cycle of relevant sensors, and calculation requirements of a reference trajectory according to this implementation. Collecting the coordinate of the preceding vehicle according to the preset cycle may, on the one hand, satisfy the computing power of the relevant processors, and on the other hand, calculate the required reference trajectory. As a possible implementation, the preset cycle may be 0.1S.

At block 102, in response to detecting an initial coordinate of the preceding vehicle in a current cycle, a circular arc between the preceding vehicle and a present vehicle is drawn, a central angle of the circular arc and a radius of the circular arc being determined according to the initial coordinate.

In detail, in an embodiment of the present disclosure, the position of the preceding vehicle is used as a planning basis for the traveling trajectory of the present vehicle, and the coordinate of the preceding vehicle is collected according to the preset cycle. If the initial coordinate of the preceding vehicle is detected within the current period, the circular arc between the preceding vehicle and the present vehicle is drawn and used as a traveling trajectory of the present vehicle. To facilitate the traveling of the present vehicle, the coordinate of the preceding vehicle in the embodiment of the present disclosure is a coordinate in a coordinate system of the present vehicle. If the initial coordinate of the preceding vehicle collected is not a coordinate in the coordinate system of the present vehicle, a coordinate system transformation is required to convert the initial coordinate of the preceding vehicle to an initial coordinate of the preceding vehicle in the coordinate system of the present vehicle.

It should be understood that, as described above, the circular arc between the present vehicle and the preceding vehicle is drawn according to the initial coordinate representing a position of the preceding vehicle, and a traveling trajectory corresponding to the circular arc corresponds to an area of a road section that the preceding vehicle has traveled. Consequently, it is safer for the present vehicle to travel according to the traveling trajectory corresponding to the circular arc.

In detail, as illustrated in FIG. 2, a circular arc may be uniquely determined according to the circular arc, the radius and the initial coordinate. To determine a specific trajectory shape of the circular arc so that the present vehicle may travel along the circular arc, the central angle of the circular arc and the radius of the circular arc may be obtained.

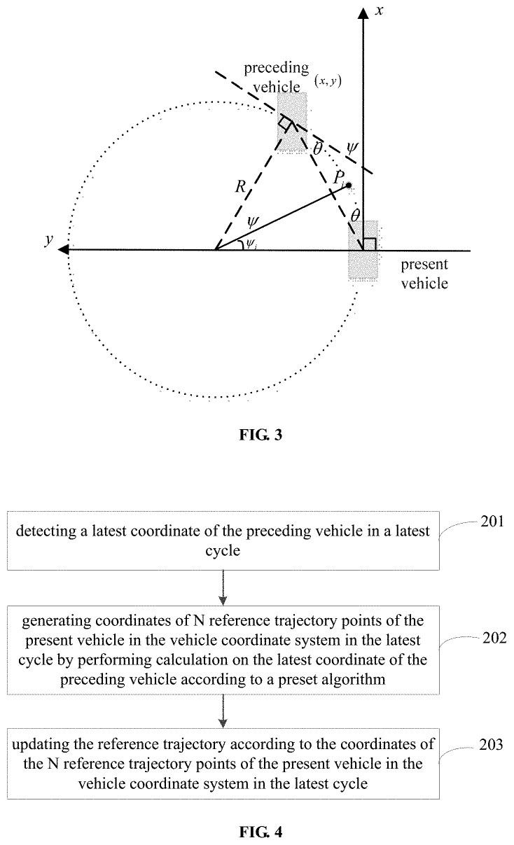

It should be noted that, according to different, the method of obtaining the central angle and the radius of the circular arc varies with application scenarios. As a possible implementation, the central angle Ψ is calculated by a following formula (1), where, referring to FIG. 3, the initial coordinate of the preceding vehicle is (x, y).

$$Ψ = {2}^{*} θ , \\ where θ = arc tan ( \frac{y}{ϰ} ) \qquad Formula ( 1 )$$

Furthermore, in this example, the radius R of the circular arc is calculated according to formula (2).

$${sin}_{-} p h i = \{ \begin{matrix}sin ( Ψ ) \vert sin ( Ψ ) \vert \geq 1.0 e - 6 \\ 1.0 e - 60.0 \leq sin ( Ψ ) \leq 1.0 e - 6 \\ - 1.0 e - 60.0 > sin ( Ψ ) > - 1.0 e - 6\end{matrix} \\ R = \frac{ϰ}{{sin}_{-} p h i} \qquad Formula ( 2 )$$

At block 103, calculation is performed on the central angle, the radius of the circular arc and a predetermined number N of reference trajectory points according to a preset algorithm to generate coordinates of N reference trajectory points of the present vehicle in a vehicle coordinate system in the current cycle.

At block 104, a reference trajectory is generated according to the coordinates of the N reference trajectory points of the present vehicle in the vehicle coordinate system in the current cycle, and the present vehicle is controlled to travel according to the reference trajectory.

It should be understood that the traveling trajectory corresponding to the circular arc is actually composed of a plurality of reference trajectory points. For the present vehicle to be able to travel along the traveling trajectory, coordinates of the plurality of reference trajectory points may be extracted from the circular arc, so that the reference trajectory is determined according to the coordinates of the reference trajectory points, and the present vehicle is controlled to travel according to the reference trajectory.

Obviously, it is not suitable when N is too high or too low. When N is too high, the calculation pressure on the system is great. When N is too low, a traveling route of the present vehicle may deviate from the safety line, leading to a traffic accident. Consequently, the number N of reference trajectory points is determined in advance and may be set according to application requirements. Generally, the number N may ensure that the present vehicle travels along the traveling trajectory that restores the above-mentioned circular arc properly, and thus the safety is guaranteed.

As a possible implementation, N is determined according to time headway τ between the present vehicle and the preceding vehicle and a path planning cycle. A sampling cycle t0 is determined according to the time headway, and t0 is a collection time period for collecting the position of the preceding vehicle required for generating the reference trajectory. Usually, t0 is set as t0≥1.2τ, so as to avoid that the reference trajectory generated cannot cover a current position of the present vehicle because t0 is too great, and to avoid waste of calculation resources because t0 is too small. In some possible embodiments, according to relevant regulations, a vehicle needs to maintain the time headway τ of at least 1.5 s to 2.2 s when traveling, so t0 may be set as 3S.

In this embodiment, formula (3) is used to obtain the number N, where T is the path planning cycle which is determined comprehensively based on factors such as computing power of relevant processors, natural motion frequency of the rigid body of the vehicle, and sampling cycle of the sensors, T may be 0.1 s, and floor indicates rounding down.

N=floor(t0/T)+1 Formula (3)

Furthermore, calculating is performed on the central angle, the radius of the circular arc and the predetermined number N of reference trajectory points according to the preset algorithm to generate the coordinates of N reference trajectory points of the present vehicle in the vehicle coordinate system in the current cycle, such that the reference trajectory is generated according to the coordinates of the N reference trajectory points of the present vehicle in the vehicle coordinate system in the current cycle, and the present vehicle is controlled to travel according to the reference trajectory.

It should be noted that, the preset algorithm for generating the coordinates of the N reference trajectory points varies with the application scenarios. As a possible implementation, the coordinates Pᵢ of the N reference trajectory points are calculated according to the following formula (4), where i represents a positive integer from 1 to N, P_{i.}_{^{x}} represents an abscissa value of the i^{th} reference trajectory point, and P_{i.}_{^{y}} represents an ordinate value of the i^{th} reference trajectory point.

$${ψ}_{i} = \frac{ψ ( i - 1 )}{N - 1} \\ {P}_{i} {ϰ}_{.} = {R}^{*} sin ( {ψ}_{i} ) \\ {P}_{i} {y}_{.} = {R}^{*} [ 1 - cos ( {ψ}_{i} ) ] \qquad Formula ( 4 )$$

It should be understood that, since the present vehicle keeps traveling, the coordinates of the N reference trajectory points in the reference trajectory may be updated according to the change of time to ensure that the reference trajectory of the vehicle is adjusted according to changes of the position of the preceding vehicle, such that the present vehicle follows the preceding vehicle, thereby ensuring driving safety.

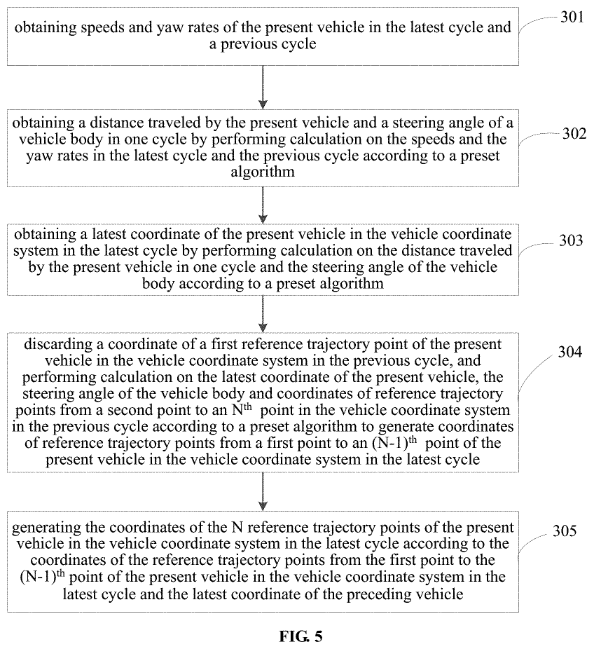

In an embodiment of the present disclosure, as illustrated in FIG. 4, after generating the coordinates of the N reference trajectory points of the present vehicle in the vehicle coordinate system in the current cycle at block 103, the method further includes the following.

At block 201, a latest coordinate of the preceding vehicle is detected in a latest cycle. The latest coordinate of the preceding vehicle reflects the latest traveling position of the preceding vehicle. In order to follow the preceding vehicle to ensure the safety of the present vehicle, the latest coordinate of the preceding vehicle may be detected.

At block 202, coordinates of N reference trajectory points of the present vehicle in the vehicle coordinate system in the latest cycle are generated by performing calculation on the latest coordinate of the preceding vehicle according to a preset algorithm.

At block 203, the reference trajectory is updated according to the coordinates of the N reference trajectory points of the present vehicle in the vehicle coordinate system in the latest cycle.

In detail, when the position of the preceding vehicle changes, the traveling trajectory of the present vehicle also changes adaptively. Therefore, in this example, the latest coordinate of the preceding vehicle is calculated according to the preset algorithm to generate the coordinates of the N reference trajectory points of the present vehicle in the vehicle coordinate system in the latest cycle, and then the reference trajectory is updated according to the coordinates of the N reference trajectory points of the present vehicle in the vehicle coordinate system in the latest cycle.

It should be noted that, in different application scenarios, different preset algorithms are used to generate the coordinates of the N reference trajectory points of the present vehicle in the vehicle coordinate system in the latest cycle. Examples are as follows.

### Example 1

In this example, the coordinates of the preceding vehicle obtained are not coordinates in the coordinate system of the present vehicle, and the coordinate system of the present vehicle changes with the change of the present vehicle. Therefore, to facilitate the traveling of the present vehicle, calculations of relevant reference trajectory points may be performed with changes of the coordinate system of the present vehicle.

In detail, as illustrated in FIG. 5, the action at block 203 includes the following.

At block 301, speeds and yaw rates of the present vehicle in the latest cycle and a previous cycle are obtained.

It should be understood that the changes in the speed and the yaw rate of the present vehicle are related to the update of the coordinate system of the present vehicle. Therefore, the speeds and the yaw rates of the present vehicle in the latest cycle and the previous cycle are obtained, such that the coordinate system of the present vehicle in the latest cycle may be determined according to changes in the speed and the yaw rate of the present vehicle.

At block 302, a distance traveled by the present vehicle and a steering angle of a vehicle body in one cycle are obtained by performing calculation on the speeds and the yaw rates in the latest cycle and the previous cycle according to the preset algorithm.

It is not difficult to understand that the change of the coordinate system of the present vehicle is reflected in the change of the distance traveled by the present vehicle and the steering angle after the speed and the yaw rate in the previous cycle change. Therefore, calculation is performed on the speeds and the yaw rates in the latest cycle and the previous cycle according to the preset algorithm to obtain the distance traveled by the present vehicle in one cycle and the steering angle of the vehicle body.

It should be noted that the preset algorithm for obtaining the distance traveled by the present vehicle in one cycle and the steering angle of the vehicle body varies with the application scenarios. As a possible implementation, formula (5) is used to calculate and obtain the distance traveled by the vehicle in one cycle and the steering angle of the vehicle body. In formula (5), the distance traveled by the vehicle in one cycle is S, the steering angle of the vehicle body is δΨ, the yaw rates of the present vehicle in the latest cycle and the previous cycle are yaw rate and yaw rate last, respectively, and the speeds of the present vehicle in the latest cycle and the previous cycle are Vₓ and Vx_last respectively.

$$S = \frac{V ϰ + V {ϰ}_{-} l a s t}{2} * T \\ δψ = \frac{y a {w}_{-} r a t e + y a {w}_{-} r a t {e}_{-} l a s t}{2} * T \\ V {ϰ}_{-} l a st = V ϰ \\ ya {w}_{-} r a t {e}_{-} l a s t = y a {w}_{-} r ate \qquad Formula ( 5 )$$

At block 303, calculation is performed on the distance traveled by the present vehicle in one cycle and the steering angle of the vehicle body according to a preset algorithm to obtain a latest coordinate of the present vehicle in the vehicle coordinate system in the latest cycle.

In detail, calculation is performed on the distance traveled by the present vehicle in one cycle and the steering angle of the vehicle body according to the preset algorithm to obtain the latest coordinate of the present vehicle in the vehicle coordinate system in the latest cycle, so that the reference trajectory may be updated according to the latest coordinate of the present vehicle.

It should be noted that, the preset algorithm for obtaining the latest coordinate of the present vehicle in the vehicle coordinate system in the latest cycle varies with application scenarios. As a possible implementation, formulas (7) and (8) are used to calculate the latest coordinate of the present vehicle. In the formulas (7) and (8), the distance traveled by the present vehicle in one cycle is S, the steering angle of the vehicle body is δΨ, a clockwise turning radius of the present vehicle is R, an abscissa value of the latest coordinate of the present vehicle is x_self, and an ordinate value of the latest coordinate of the present vehicle is y_self.

$$\begin{matrix}R = \{ \begin{matrix}S / δψ \vert δψ \vert \geq 1.0 e - 6 \\ S / 1.0 e - 60.0 > δψ < 1.0 e - 6 \\ S / - 1.0 e - 60.0 > δψ > - 1.0 e - 6\end{matrix} & Formula ( 7 ) \\ {ϰ}_{-} s e l f = {R}^{*} sin ( δψ ) \\ {y}_{-} s elf = {R}^{*} [ 1 - cos ( δψ ) ] & Formula ( 8 )\end{matrix}$$

At block 304, a coordinate of a first reference trajectory point of the present vehicle in the vehicle coordinate system in the previous cycle is discarded, and calculation is performed on the latest coordinate of the present vehicle, the steering angle of the vehicle body and coordinates of reference trajectory points from a second point to an N^{th} point in the vehicle coordinate system in the previous cycle according to a preset algorithm to generate coordinates of reference trajectory points from a first point to an (N−1)^{th} point of the present vehicle in the vehicle coordinate system in the latest cycle.

At block 305, the coordinates of the N reference trajectory points of the present vehicle in the vehicle coordinate system in the latest cycle are generated according to the coordinates of the reference trajectory points from the first point to the (N−1)^{th} point of the present vehicle in the vehicle coordinate system in the latest cycle and the latest coordinate of the preceding vehicle.

In detail, it is obvious that, during the traveling of the present vehicle, the first reference trajectory point in the previous cycle is covered with the traveling of the present vehicle. Therefore, the coordinate of the first reference trajectory point of the present vehicle in the vehicle coordinate system in the previous cycle is discarded, and the calculation is performed on the latest coordinate of the present vehicle, the steering angle of the vehicle body and the coordinates of reference trajectory points from the second point to the N^{th} point in the vehicle coordinate system in the previous cycle according to the preset algorithm to generate the coordinates of reference trajectory points from the first point to the (N−1)^{th} point of the present vehicle in the vehicle coordinate system in the latest cycle. In other words, the coordinates of reference trajectory points from the second point to the N^{th} point in the previous cycle are converted from the coordinate system of the present vehicle in the previous cycle to the coordinate system of the present vehicle in the latest cycle. In different application scenarios, different preset algorithms are used to perform calculation on the latest coordinate of the present vehicle, the steering angle of the vehicle body and the coordinates of reference trajectory points from the second point to the N^{th} point in the vehicle coordinate system in the previous cycle. As a possible embodiment, formula (9) may be used to generate the coordinates of reference trajectory points from the first point to the (N−1)^{th} point of the present vehicle in the vehicle coordinate system in the latest cycle. In formula (9), the coordinate system transformation is performed on the coordinates Pᵢ(2≤i≤N) of reference trajectory points from the second point to the N^{th} point in the previous cycle. The abscissas and ordinates of the reference trajectory points in the latest cycle are represented by P_{i.}_{^{x}} and P_{i.}_{^{y}}, respectively, the abscissas and ordinates of the reference trajectory points in the previous cycle are represented by P_{i.}_{^{x-x_self}} and P_{i.}_{^{y-y_self}}, respectively, and the steering angle of the vehicle body is δΨ.

$$[ \begin{matrix}{P}_{i} {ϰ}_{.} \\ {P}_{i} {y}_{.}\end{matrix} ] = [ \begin{matrix}cos ( δψ ) & sin ( δψ ) \\ - s in ( δψ ) & cos ( δψ )\end{matrix} ] [ \begin{matrix}{P}_{i} {ϰ}_{.} - ϰ\_ self \\ {P}_{i} {y}_{.} - y \_ self\end{matrix} ] ( 2 \leq i \leq N ) \qquad Formula ( 9 )$$

Furthermore, the coordinates of the N reference trajectory points of the present vehicle in the vehicle coordinate system in the latest cycle are generated according to the coordinates of the reference trajectory points from the first point to the (N−1)^{th} point of the present vehicle in the vehicle coordinate system in the latest cycle and the latest coordinate of the preceding vehicle. As described above, the coordinates of the reference trajectory points from the first point to the (N−1)^{th} point of the present vehicle in the vehicle coordinate system in the latest cycle are obtained by performing calculation on the coordinates of the reference trajectory points from the second point to the N^{th} point collected in the previous cycle. The coordinate of the N^{th} reference trajectory point of the present vehicle in the vehicle coordinate system in the latest cycle is obtained by converting the latest coordinate of the preceding vehicle collected in the current cycle into a coordinate in the vehicle coordinate system of the present vehicle.

As a possible implementation, based on the calculation results of formulas (7) to (9), formula (10) is used to calculate and obtain the coordinates of the N reference trajectory points of the present vehicle in the vehicle coordinate system in the latest cycle.

$$[ \begin{matrix}{P}_{i} {ϰ}_{.} \\ {P}_{i} {y}_{.}\end{matrix} ] = [ \begin{matrix}{P}_{i + 1} {ϰ}_{.} \\ {P}_{i + 1} {y}_{.}\end{matrix} ] ( 1 \leq i \leq N - 1 ) \\ [ \begin{matrix}{P}_{N} {ϰ}_{.} \\ {P}_{N} {y}_{.}\end{matrix} ] = [ \begin{matrix}ϰ \\ y\end{matrix} ] \qquad Formula ( 10 )$$

### Example 2

In this example, a global navigation satellite system is introduced to measure a position (including longitude lon and latitude lat) of the present vehicle in a geographic coordinate system in real time. That is, an absolute coordinate and a heading angle of the present vehicle are measured. An inertial measurement unit is introduced to measure the heading angle, which may be understood as an angle φ between the present vehicle and the north direction, and in this example, the north direction is defined as positive. In other words, when obtaining the absolute coordinate and the heading angle of the present vehicle, it is unnecessary to update the reference trajectory by converting coordinates of relevant reference trajectory points to adapt to changes in the coordinate system of the present vehicle.

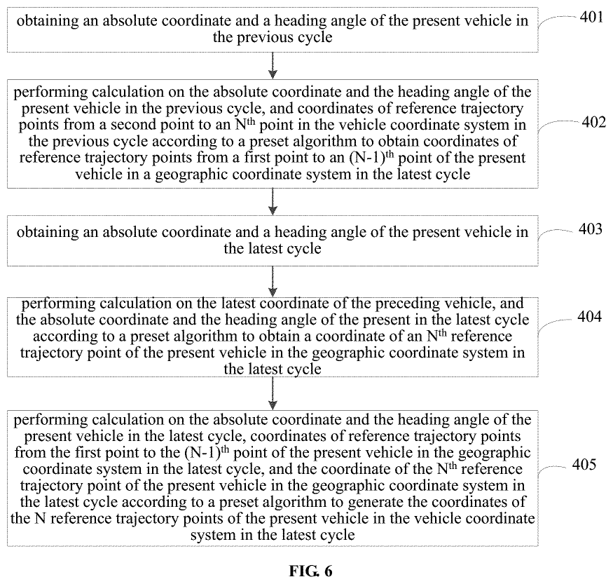

In detail, as illustrated in FIG. 6, the action at block 203 includes the following.

At block 401, an absolute coordinate and a heading angle of the present vehicle in the previous cycle are obtained.

In detail, a global navigation positioning system and an inertial measurement device may be used to measure the absolute coordinate and the heading angle of the present vehicle in the previous cycle. Instead of taking the present vehicle as a reference coordinate system, the absolute coordinate and the heading angle take external environment such as the earth as the reference coordinate system, so that the absolute coordinate and the heading angle do not change with the change of the present vehicle.

At block 402, calculation is performed on the absolute coordinate and the heading angle of the present vehicle in the previous cycle, and the coordinates of reference trajectory points from the second point to the N^{th} point in the vehicle coordinate system in the previous cycle according to a preset algorithm to obtain the coordinates of reference trajectory points from the first point to the (N−1)^{th} point of the present vehicle in the geographic coordinate system in the latest cycle.

In detail, the coordinates of the reference trajectory points from the second point to the N^{th} point in the previous cycle are calculated according to the preset algorithm to be converted into the coordinates of the reference trajectory points from the first point to the (N−1)^{th} point of the present vehicle in the latest cycle. That is, the coordinate of the first reference trajectory point collected in the previous cycle is covered, and the coordinates of the reference trajectory points from the second point to the N^{th} point are updated as the coordinates of the reference trajectory points from the first point to the (N−1)^{th} point in the latest cycle. In this embodiment, for the convenience of calculation, the absolute coordinate is used to represent a reference trajectory coordinate. An abscissa of the absolute coordinate is a longitude value, and an ordinate of the absolute coordinate is a latitude value.

It should be noted that, in different application scenarios, different preset algorithms are used to obtain the coordinates of the reference trajectory points from the first point to the (N−1)^{th} point of the present vehicle in the geographic coordinate system in the latest cycle. As a possible implementation, formula (11) is used for calculation, where in formula (11), the abscissas and ordinates of the reference trajectory points are represented by P_{i.}_{^{lon}} and P_{i.}_{^{lat}}, respectively.

$$[ \begin{matrix}{P}_{i} {l}_{.} on \\ {P}_{i} {l}_{.} at\end{matrix} ] = [ \begin{matrix}{P}_{i + 1} {l}_{.} on \\ {P}_{i + 1} {l}_{.} at\end{matrix} ] ( 1 \leq i \leq N - 1 ) \qquad Formula ( 11 )$$

At block 403, an absolute coordinate and a heading angle of the present vehicle in the latest cycle are obtained.

Similarly, the global navigation positioning system and the inertial measurement device may be used to measure the absolute coordinate and the heading angle of the present vehicle in the latest cycle.

At block 404, calculation is performed on the latest coordinate of the preceding vehicle, and the absolute coordinate and the heading angle of the present in the latest cycle according to the preset algorithm to obtain a coordinate of an N^{th} reference trajectory point of the present vehicle in the geographic coordinate system in the latest cycle.

As a possible implementation, formula (12) is used to calculate the coordinate of the N^{th} reference trajectory point of the present vehicle in the geographic coordinate system in the latest cycle. An abscissa value and an ordinate value of the latest coordinate of the preceding vehicle in the vehicle coordinate system of the present vehicle are represented by x and y, respectively, and an abscissa value and an ordinate value of the latest coordinate of the present vehicle in the vehicle coordinate system of the present vehicle in the latest cycle are represented by X and Y, respectively.

$$[ \begin{matrix}X \\ Y\end{matrix} ] = [ \begin{matrix}cos ( ϕ ) & - sin ( ϕ ) \\ sin ( ϕ ) & cos ( ϕ )\end{matrix} ] [ \begin{matrix}ϰ \\ y\end{matrix} ] \\ [ \begin{matrix}{P}_{N} {l}_{.} on \\ {P}_{N} {l}_{.} at\end{matrix} ] = [ \begin{matrix}l o n \\ l a t\end{matrix} ] + [ \begin{matrix}Y / [ R {e}^{*} cos ( lat ) ] \\ X / R e\end{matrix} ] \qquad Formula ( 12 )$$

At block 405, calculation is performed on the absolute coordinate and the heading angle of the present vehicle in the latest cycle, the coordinates of the reference trajectory points from the first point to the (N−1)^{th} point of the present vehicle in the geographic coordinate system in the latest cycle, and the coordinate of the N^{th} reference trajectory point of the present vehicle in the geographic coordinate system in the latest cycle according to a preset algorithm to generate the coordinates of the N reference trajectory points of the present vehicle in the vehicle coordinate system in the latest cycle.

In detail, after obtaining the coordinates of the reference trajectory points from the first point to the N^{th} point of the present vehicle in the latest cycle, the reference trajectory is updated according to the first to the N^{th} reference trajectory points. That is, calculation is performed on the absolute coordinate and the heading angle of the present vehicle in the latest cycle, the coordinates of the reference trajectory points from the first point to the (N−1)^{th} point of the present vehicle in the geographic coordinate system in the latest cycle, and the coordinate of the N^{th} reference trajectory point of the present vehicle in the geographic coordinate system in the latest cycle according to the preset algorithm to generate the coordinates of the N reference trajectory points of the present vehicle in the vehicle coordinate system in the latest cycle, so as to update the reference trajectory according to the coordinates of the N reference trajectory points.

Since in actual applications, the present vehicle usually travels in the coordinate system of the present vehicle, the coordinates Pᵢ_{^{(lon,lat)}} of the reference trajectory points from the first point to the N^{th} point in the absolute coordinate system in the latest cycle generated in the above steps need to be transformed into the coordinates Pᵢ_{^{(x,y)}} of the N reference trajectory points in the coordinate system of the present vehicle.

As a possible implementation, formula (13) is used to perform the calculation on the coordinate of the N^{th} reference trajectory point of the present vehicle in the geographic coordinate system in the latest cycle to generate the coordinates of the N reference trajectory points of the present vehicle in the vehicle coordinate system in the latest cycle.

$$[ \begin{matrix}{P}_{i} {ϰ}_{.} \\ {P}_{i} {y}_{.}\end{matrix} ] = [ \begin{matrix}cos ( ϕ ) & sin ( ϕ ) \\ - s in ( ϕ ) & cos ( ϕ )\end{matrix} ] [ \begin{matrix}{( {P}_{i} {l}_{.} at - la t )}^{*} R e \\ {( {P}_{i} {l}_{.} on - lo n )}^{*} R {e}^{*} cos ( lat )\end{matrix} ] \qquad Formula ( 13 )$$

In summary, with the unmanned vehicle traveling method according to the embodiments of the present disclosure, the traveling trajectory of the present vehicle is planned according to the position of the preceding vehicle, so that it is ensured that the reference traveling trajectory of the present vehicle may still be planned when no lane is detected or when a failure happens on the camera, which improves traveling safety of the present vehicle and is significant to promotion of unmanned vehicles.

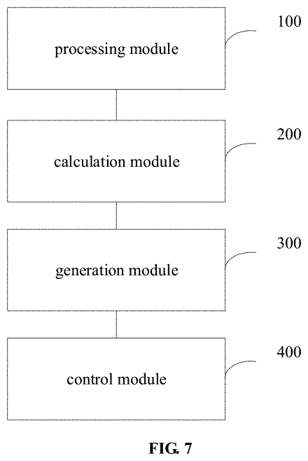

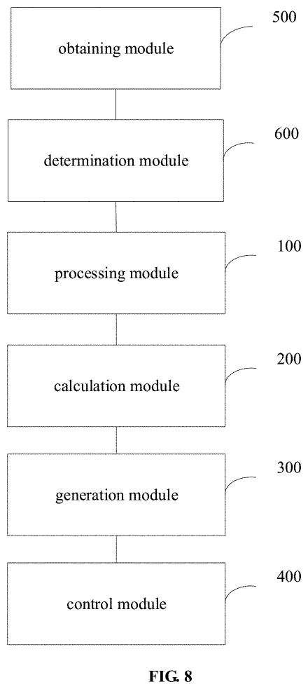

To implement the above embodiments, the present disclosure further provides an unmanned vehicle traveling apparatus. FIG. 7 is a schematic structural diagram of an unmanned vehicle traveling apparatus according to an embodiment of the present disclosure. As illustrated in FIG. 7, the apparatus includes: a processing module 100, a calculation module 200, a generation module 300 and a control module 400.

The processing module 200 is configured to collect a coordinate of a preceding vehicle according to a preset cycle, and in response to detecting an initial coordinate of the preceding vehicle in a current cycle, to draw a circular arc between the preceding vehicle and a present vehicle.

The calculation module 200 is configured to determine a central angle of the circular arc and a radius of the circular arc according to the initial coordinate.

The generation module 300 is configured to perform calculation on the central angle, the radius of the circular arc and a predetermined number N of reference trajectory points according to a preset algorithm to generate coordinates of N reference trajectory points of the present vehicle in a vehicle coordinate system in the current cycle.

The control module 400 is configured to generate a reference trajectory according to the coordinates of the N reference trajectory points of the present vehicle in the vehicle coordinate system in the current cycle, and to control the present vehicle to travel according to the reference trajectory.

In an embodiment of the present disclosure, as illustrated in FIG. 8, and on the basis of FIG. 7, the apparatus further includes an obtaining module 500 and a determination module 600.

The obtaining module 500 is configured to obtain time headway between the present vehicle and the preceding vehicle and a path planning cycle.

The determination module 600 is configured to determine the number N of reference trajectory points by performing calculation on the time headway and the path planning cycle according to a preset algorithm.

It should be noted that the foregoing explanation of the embodiments of the unmanned vehicle traveling method is also applicable to the unmanned vehicle traveling apparatus according to this embodiment, and the implementation principles thereof are similar, and will not be repeated here.

In summary, with the unmanned vehicle traveling apparatus according to the embodiments of the present disclosure, the traveling trajectory of the present vehicle is planned according to the position of the preceding vehicle, so that it is ensured that the reference traveling trajectory of the present vehicle may still be planned when no lane is detected, or when a camera failure happens, which improves traveling safety of the present vehicle and is significant to promotion unmanned vehicles.

To implement the above embodiments, the present disclosure further provides a computer device including a processor. The processor, by reading executable program codes stored in a memory, executes a program corresponding to the executable program codes to implement the unmanned vehicle traveling method as described in the above embodiments.

To implement the above embodiments, the present disclosure further provides a non-transitory computer-readable storage medium. When an instruction in the storage medium is executed by a processor, the unmanned vehicle traveling method as described in the above embodiments is implemented.

To implement the above embodiments, the present disclosure further provides a computer program product. When an instruction in the computer program product is executed by a processor, the unmanned vehicle traveling method as described in the above embodiments is implemented.

Reference throughout this specification to “an embodiment,” “some embodiments,” “an example,” “a specific example,” or “some examples,” means that a particular feature, structure, material, or characteristic described in connection with the embodiment or example is included in at least one embodiment or example of the present disclosure. The appearances of the above phrases in various places throughout this specification are not necessarily referring to the same embodiment or example of the present disclosure. Furthermore, the particular features, structures, materials, or characteristics may be combined in any suitable manner in one or more embodiments or examples. In addition, different embodiments or examples and features of different embodiments or examples described in the specification may be combined by those skilled in the art without mutual contradiction.

In addition, terms such as “first” and “second” are used herein for purposes of description and are not intended to indicate or imply relative importance or significance. Thus, the feature defined with “first” and “second” may comprise one or more this feature. In the description of the present disclosure, “a plurality of” means at least two, for example, two or three, unless specified otherwise.

Any process or method described in a flow chart or described herein in other ways may be understood to include one or more modules, segments or portions of codes of executable instructions for achieving specific logical functions or steps in the process, and the scope of a preferred embodiment of the present disclosure includes other implementations, which should be understood by those skilled in the art.

The logic and/or step described in other manners herein or shown in the flow chart, for example, a particular sequence table of executable instructions for realizing the logical function, may be specifically achieved in any computer readable medium to be used by the instruction execution system, device or equipment (such as the system based on computers, the system comprising processors or other systems capable of obtaining the instruction from the instruction execution system, device and equipment and executing the instruction), or to be used in combination with the instruction execution system, device and equipment. As to the specification, “the computer readable medium” may be any device adaptive for including, storing, communicating, propagating or transferring programs to be used by or in combination with the instruction execution system, device or equipment. More specific examples of the computer readable medium comprise but are not limited to: an electronic connection (an electronic device) with one or more wires, a portable computer enclosure (a magnetic device), a random access memory (RAM), a read only memory (ROM), an erasable programmable read-only memory (EPROM or a flash memory), an optical fiber device and a portable compact disk read-only memory (CDROM). In addition, the computer readable medium may even be a paper or other appropriate medium capable of printing programs thereon, this is because, for example, the paper or other appropriate medium may be optically scanned and then edited, decrypted or processed with other appropriate methods when necessary to obtain the programs in an electric manner, and then the programs may be stored in the computer memories.

It should be understood that each part of the present disclosure may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

It would be understood by those skilled in the art that all or a part of the steps carried by the method in the above-described embodiments may be completed by relevant hardware instructed by a program. The program may be stored in a computer readable storage medium. When the program is executed, one or a combination of the steps of the method in the above-described embodiments may be completed.

In addition, individual functional units in the embodiments of the present disclosure may be integrated in one processing module or may be separately physically present, or two or more units may be integrated in one module. The integrated module as described above may be achieved in the form of hardware, or may be achieved in the form of a software functional module. If the integrated module is achieved in the form of a software functional module and sold or used as a separate product, the integrated module may also be stored in a computer readable storage medium.

The storage medium mentioned above may be read-only memories, magnetic disks or CD, etc. Although explanatory embodiments have been shown and described, it would be appreciated by those skilled in the art that the above embodiments cannot be construed to limit the present disclosure, and changes, alternatives, and modifications can be made in the embodiments without departing from scope of the present disclosure.

1. An unmanned vehicle traveling method, comprising:
collecting a coordinate of a preceding vehicle according to a preset cycle;
in response to detecting an initial coordinate of the preceding vehicle in a current cycle, determining a circular arc between the preceding vehicle and a present vehicle, wherein a central angle of the circular arc and a radius of the circular arc being determined according to the initial coordinate;
performing calculation on the central angle, the radius of the circular arc and a predetermined number N of reference trajectory points according to a preset algorithm, and generating coordinates of N reference trajectory points of the present vehicle in a vehicle coordinate system in the current cycle; and
generating a reference trajectory according to the coordinates of the N reference trajectory points of the present vehicle in the vehicle coordinate system in the current cycle, and controlling the present vehicle to travel according to the reference trajectory.

2. The method according to claim 1, further comprising:
obtaining time headway between the present vehicle and the preceding vehicle and a path planning cycle; and
determining the number N of reference trajectory points by performing calculation on the time headway and the path planning cycle according to a preset algorithm.

3. The method according to claim 1, after generating the coordinates of the N reference trajectory points of the present vehicle in the vehicle coordinate system in the current cycle, further comprising:
detecting a latest coordinate of the preceding vehicle in a latest cycle;
generating coordinates of N reference trajectory points of the present vehicle in the vehicle coordinate system in the latest cycle by performing calculation on the latest coordinate of the preceding vehicle according to a preset algorithm; and
updating the reference trajectory according to the coordinates of the N reference trajectory points of the present vehicle in the vehicle coordinate system in the latest cycle.

4. The method according to claim 3, wherein generating the coordinates of the N reference trajectory points of the present vehicle in the vehicle coordinate system in the latest cycle by performing calculation on the latest coordinates of the preceding vehicle according to the preset algorithm comprises:
obtaining speeds and yaw rates of the present vehicle in the latest cycle and a previous cycle;
obtaining a distance traveled by the present vehicle and a steering angle of a vehicle body in one cycle by performing calculation on the speeds and the yaw rates in the latest cycle and the previous cycle according to a preset algorithm;
obtaining a latest coordinate of the present vehicle in the vehicle coordinate system in the latest cycle by performing calculation on the distance traveled by the present vehicle in one cycle and the steering angle of the vehicle body according to a preset algorithm;
discarding a coordinate of a first reference trajectory point of the present vehicle in the vehicle coordinate system in the previous cycle, and performing calculation on the latest coordinate of the present vehicle, the steering angle of the vehicle body and coordinates of reference trajectory points from a second point to an N^{th} point in the vehicle coordinate system in the previous cycle according to a preset algorithm to generate coordinates of reference trajectory points from a first point to an (N−1)^{th} point of the present vehicle in the vehicle coordinate system in the latest cycle; and
generating the coordinates of the N reference trajectory points of the present vehicle in the vehicle coordinate system in the latest cycle according to the coordinates of the reference trajectory points from the first point to the (N−1)^{th} point of the present vehicle in the vehicle coordinate system in the latest cycle and the latest coordinate of the preceding vehicle.

5. The method according to claim 3, wherein generating the coordinates of N reference trajectory points of the present vehicle in the vehicle coordinate system in the latest cycle by performing calculation on the latest coordinates of the preceding vehicle according to the preset algorithm comprises:
obtaining an absolute coordinate and a heading angle of the present vehicle in the previous cycle;
performing calculation on the absolute coordinate and the heading angle of the present vehicle in the previous cycle, and coordinates of reference trajectory points from a second point to an N^{th} point in the vehicle coordinate system in the previous cycle according to a preset algorithm to obtain coordinates of reference trajectory points from a first point to an (N−1)^{th} point of the present vehicle in a geographic coordinate system in the latest cycle;
obtaining an absolute coordinate and a heading angle of the present vehicle in the latest cycle;
performing calculation on the latest coordinate of the preceding vehicle, and the absolute coordinate and the heading angle of the present in the latest cycle according to a preset algorithm to obtain a coordinate of an N^{th} reference trajectory point of the present vehicle in the geographic coordinate system in the latest cycle; and
performing calculation on the absolute coordinate and the heading angle of the present vehicle in the latest cycle, coordinates of reference trajectory points from the first point to the (N−1)^{th} point of the present vehicle in the geographic coordinate system in the latest cycle, and the coordinate of the N^{th} reference trajectory point of the present vehicle in the geographic coordinate system in the latest cycle according to a preset algorithm to generate the coordinates of the N reference trajectory points of the present vehicle in the vehicle coordinate system in the latest cycle.

6-10. (canceled)

11. A computer device, comprising a memory, a processor and a computer program stored on the memory and executable by the processor, wherein when the processor executes the program, the processor is configured to implement the unmanned vehicle traveling method, the method comprising:
collecting a coordinate of a preceding vehicle according to a preset cycle, and in response to detecting an initial coordinate of the preceding vehicle in a current cycle;
determining a circular arc between the preceding vehicle and a present vehicle, wherein a central angle of the circular arc and a radius of the circular arc being determined according to the initial coordinate;
performing calculation on the central angle, the radius of the circular arc and a predetermined number N of reference trajectory points according to a preset algorithm, and generating coordinates of N reference trajectory points of the present vehicle in a vehicle coordinate system in the current cycle; and
generating a reference trajectory according to the coordinates of the N reference trajectory points of the present vehicle in the vehicle coordinate system in the current cycle, and controlling the present vehicle to travel according to the reference trajectory.

12. A non-transitory computer-readable storage medium having a computer program stored thereon, wherein when the computer program is executed by a processor, an unmanned vehicle traveling method is implemented, the method comprising:
collecting a coordinate of a preceding vehicle according to a preset cycle, and in response to detecting an initial coordinate of the preceding vehicle in a current cycle;
determining a circular arc between the preceding vehicle and a present vehicle, wherein a central angle of the circular arc and a radius of the circular arc being determined according to the initial coordinate;
performing calculation on the central angle, the radius of the circular arc and a predetermined number N of reference trajectory points according to a preset algorithm, and generating coordinates of N reference trajectory points of the present vehicle in a vehicle coordinate system in the current cycle; and
generating a reference trajectory according to the coordinates of the N reference trajectory points of the present vehicle in the vehicle coordinate system in the current cycle, and controlling the present vehicle to travel according to the reference trajectory.

13. (canceled)

14. The method according to claim 2, after generating the coordinates of the N reference trajectory points of the present vehicle in the vehicle coordinate system in the current cycle, further comprising:
detecting a latest coordinate of the preceding vehicle in a latest cycle;
generating coordinates of N reference trajectory points of the present vehicle in the vehicle coordinate system in the latest cycle by performing calculation on the latest coordinate of the preceding vehicle according to a preset algorithm; and
updating the reference trajectory according to the coordinates of the N reference trajectory points of the present vehicle in the vehicle coordinate system in the latest cycle.

15. The computer device according to claim 11, wherein the method further comprises:
obtaining time headway between the present vehicle and the preceding vehicle and a path planning cycle; and
determining the number N of reference trajectory points by performing calculation on the time headway and the path planning cycle according to a preset algorithm.

16. The computer device according to claim 11, wherein, after generating the coordinates of the N reference trajectory points of the present vehicle in the vehicle coordinate system in the current cycle, further comprises:
detecting a latest coordinate of the preceding vehicle in a latest cycle;
generating coordinates of N reference trajectory points of the present vehicle in the vehicle coordinate system in the latest cycle by performing calculation on the latest coordinate of the preceding vehicle according to a preset algorithm; and
updating the reference trajectory according to the coordinates of the N reference trajectory points of the present vehicle in the vehicle coordinate system in the latest cycle.

17. The computer device according to claim 15, wherein, after generating the coordinates of the N reference trajectory points of the present vehicle in the vehicle coordinate system in the current cycle, further comprises:
detecting a latest coordinate of the preceding vehicle in a latest cycle;
generating coordinates of N reference trajectory points of the present vehicle in the vehicle coordinate system in the latest cycle by performing calculation on the latest coordinate of the preceding vehicle according to a preset algorithm; and
updating the reference trajectory according to the coordinates of the N reference trajectory points of the present vehicle in the vehicle coordinate system in the latest cycle.

18. The computer device according to claim 16, wherein generating the coordinates of the N reference trajectory points of the present vehicle in the vehicle coordinate system in the latest cycle by performing calculation on the latest coordinates of the preceding vehicle according to the preset algorithm comprises:
obtaining speeds and yaw rates of the present vehicle in the latest cycle and a previous cycle;
obtaining a distance traveled by the present vehicle and a steering angle of a vehicle body in one cycle by performing calculation on the speeds and the yaw rates in the latest cycle and the previous cycle according to a preset algorithm;
obtaining a latest coordinate of the present vehicle in the vehicle coordinate system in the latest cycle by performing calculation on the distance traveled by the present vehicle in one cycle and the steering angle of the vehicle body according to a preset algorithm;
discarding a coordinate of a first reference trajectory point of the present vehicle in the vehicle coordinate system in the previous cycle, and performing calculation on the latest coordinate of the present vehicle, the steering angle of the vehicle body and coordinates of reference trajectory points from a second point to an N^{th} point in the vehicle coordinate system in the previous cycle according to a preset algorithm to generate coordinates of reference trajectory points from a first point to an (N−1)^{th} point of the present vehicle in the vehicle coordinate system in the latest cycle; and
generating the coordinates of the N reference trajectory points of the present vehicle in the vehicle coordinate system in the latest cycle according to the coordinates of the reference trajectory points from the first point to the (N−1)^{th} point of the present vehicle in the vehicle coordinate system in the latest cycle and the latest coordinate of the preceding vehicle.

19. The computer device according to claim 16 wherein generating the coordinates of the N reference trajectory points of the present vehicle in the vehicle coordinate system in the latest cycle by performing calculation on the latest coordinates of the preceding vehicle according to the preset algorithm comprises:
obtaining an absolute coordinate and a heading angle of the present vehicle in the previous cycle;
performing calculation on the absolute coordinate and the heading angle of the present vehicle in the previous cycle, and coordinates of reference trajectory points from a second point to an N^{th} point in the vehicle coordinate system in the previous cycle according to a preset algorithm to obtain coordinates of reference trajectory points from a first point to an (N−1)^{th} point of the present vehicle in a geographic coordinate system in the latest cycle;
obtaining an absolute coordinate and a heading angle of the present vehicle in the latest cycle;
performing calculation on the latest coordinate of the preceding vehicle, and the absolute coordinate and the heading angle of the present in the latest cycle according to a preset algorithm to obtain a coordinate of an N^{th} reference trajectory point of the present vehicle in the geographic coordinate system in the latest cycle; and
performing calculation on the absolute coordinate and the heading angle of the present vehicle in the latest cycle, coordinates of reference trajectory points from the first point to the (N−1)^{th} point of the present vehicle in the geographic coordinate system in the latest cycle, and the coordinate of the N^{th} reference trajectory point of the present vehicle in the geographic coordinate system in the latest cycle according to a preset algorithm to generate the coordinates of the N reference trajectory points of the present vehicle in the vehicle coordinate system in the latest cycle.

20. The storage medium according to claim 12, wherein the method further comprises:
obtaining time headway between the present vehicle and the preceding vehicle and a path planning cycle; and
determining the number N of reference trajectory points by performing calculation on the time headway and the path planning cycle according to a preset algorithm.

21. The storage medium according to claim 12, wherein, after generating the coordinates of the N reference trajectory points of the present vehicle in the vehicle coordinate system in the current cycle, further comprises:
detecting a latest coordinate of the preceding vehicle in a latest cycle;
generating coordinates of N reference trajectory points of the present vehicle in the vehicle coordinate system in the latest cycle by performing calculation on the latest coordinate of the preceding vehicle according to a preset algorithm; and
updating the reference trajectory according to the coordinates of the N reference trajectory points of the present vehicle in the vehicle coordinate system in the latest cycle.

22. The storage medium according to claim 20, wherein, after generating the coordinates of the N reference trajectory points of the present vehicle in the vehicle coordinate system in the current cycle, further comprises:
detecting a latest coordinate of the preceding vehicle in a latest cycle;
generating coordinates of N reference trajectory points of the present vehicle in the vehicle coordinate system in the latest cycle by performing calculation on the latest coordinate of the preceding vehicle according to a preset algorithm; and
updating the reference trajectory according to the coordinates of the N reference trajectory points of the present vehicle in the vehicle coordinate system in the latest cycle.

23. The storage medium according to claim 21, wherein generating the coordinates of the N reference trajectory points of the present vehicle in the vehicle coordinate system in the latest cycle by performing calculation on the latest coordinates of the preceding vehicle according to the preset algorithm comprises:
obtaining speeds and yaw rates of the present vehicle in the latest cycle and a previous cycle;
obtaining a distance traveled by the present vehicle and a steering angle of a vehicle body in one cycle by performing calculation on the speeds and the yaw rates in the latest cycle and the previous cycle according to a preset algorithm;
obtaining a latest coordinate of the present vehicle in the vehicle coordinate system in the latest cycle by performing calculation on the distance traveled by the present vehicle in one cycle and the steering angle of the vehicle body according to a preset algorithm;
discarding a coordinate of a first reference trajectory point of the present vehicle in the vehicle coordinate system in the previous cycle, and performing calculation on the latest coordinate of the present vehicle, the steering angle of the vehicle body and coordinates of reference trajectory points from a second point to an N^{th} point in the vehicle coordinate system in the previous cycle according to a preset algorithm to generate coordinates of reference trajectory points from a first point to an (N−1)^{th} point of the present vehicle in the vehicle coordinate system in the latest cycle; and
generating the coordinates of the N reference trajectory points of the present vehicle in the vehicle coordinate system in the latest cycle according to the coordinates of the reference trajectory points from the first point to the (N−1)^{th} point of the present vehicle in the vehicle coordinate system in the latest cycle and the latest coordinate of the preceding vehicle.

24. The storage medium according to claim 21, wherein generating the coordinates of the N reference trajectory points of the present vehicle in the vehicle coordinate system in the latest cycle by performing calculation on the latest coordinates of the preceding vehicle according to the preset algorithm comprises:
obtaining an absolute coordinate and a heading angle of the present vehicle in the previous cycle;
performing calculation on the absolute coordinate and the heading angle of the present vehicle in the previous cycle, and coordinates of reference trajectory points from a second point to an N^{th} point in the vehicle coordinate system in the previous cycle according to a preset algorithm to obtain coordinates of reference trajectory points from a first point to an (N−1)^{th} point of the present vehicle in a geographic coordinate system in the latest cycle;
obtaining an absolute coordinate and a heading angle of the present vehicle in the latest cycle;
performing calculation on the latest coordinate of the preceding vehicle, and the absolute coordinate and the heading angle of the present in the latest cycle according to a preset algorithm to obtain a coordinate of an N^{th} reference trajectory point of the present vehicle in the geographic coordinate system in the latest cycle; and
performing calculation on the absolute coordinate and the heading angle of the present vehicle in the latest cycle, coordinates of reference trajectory points from the first point to the (N−1)^{th} point of the present vehicle in the geographic coordinate system in the latest cycle, and the coordinate of the N^{th} reference trajectory point of the present vehicle in the geographic coordinate system in the latest cycle according to a preset algorithm to generate the coordinates of the N reference trajectory points of the present vehicle in the vehicle coordinate system in the latest cycle.
